(19) United States
(12) Patent Application Publication
(10) Pub. No.: US 2026/0122090 A1
(43) Pub. Date: Apr. 30, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Shunichi Kinoshita, Tokyo (JP); Tomohiko Yagyu, Tokyo (JP)

(73) Assignee: NEC Corporation, Tokyo (JP)

(21) Appl. No.: 19/351,400

(22) Filed: Oct. 7, 2025

(30) Foreign Application Priority Data
Oct. 29, 2024 (JP) 2024-189886

(51) Int. Cl. H04L 9/40

(52) U.S. Cl. CPC H04L 63/1425; H04L 63/20

(57) ABSTRACT

An information processing apparatus includes a related log selection unit that specifies an attack path related to a security alert and specifies a log related to the specified attack path in a computer system including hosts, and a related log instruction unit that instructs the host that handles the specified log to store the specified log.

This application is based upon and claims the benefit of priority from Japanese patent application No. 2024-189886, filed on Oct. 29, 2024, the disclosure of which is incorporated herein in its entirety by reference.

### TECHNICAL FIELD

The present disclosure relates to a technology that supports analysis of logs in a computer system.

### BACKGROUND ART

In recent years, cyberattacks targeting computer systems of organizations such as companies and government offices have increased. When the computer system is subjected to the cyberattack, a malicious program such as malware illegally intrudes into the computer system, and steals, destroys, or falsifies data. In order to cope with such a cyberattack, an administrator of the system needs to analyze logs collected in the object system. JP 2023-115443 A discloses an apparatus that supports analysis of logs in a system.

The apparatus disclosed in JP 2023-115443 A specifies logs enabling to detect an attack among logs collected in a system to be monitored, and generates a combination of the specified logs as a log set. The apparatus disclosed in JP 2023-115443 A also generates a plurality of the log sets, and sets a priority indicating a degree of priority of monitoring for each log set. An administrator of the system can efficiently cope with a targeted attack by analyzing the logs starting with the highest priority log set among the logs collected from the system.

In recent years, since vehicles themselves are increasingly connected to external networks, cyberattacks on in-vehicle networks mounted on vehicles are also concerned. Therefore, WO 2022-091754 A1 discloses an apparatus for coping with a cyberattack on an in-vehicle network.

When an anomaly is detected in the in-vehicle network, the apparatus disclosed in WO 2022-091754 A1 estimates an attack route based on a preset candidate for the attack route, and determines a device on the estimated attack route as an object to be analyzed. The apparatus disclosed in WO 2022-091754 A1 then requests the device determined as the object to be analyzed to transmit logs, and collects the transmitted logs. Since the collected logs are logs related to an attack, according to the apparatus disclosed in WO 2022-091754 A1, it is possible to efficiently analyze the cyberattack on the in-vehicle network.

### SUMMARY

Meanwhile, the apparatus disclosed in JP 2023-115443 A has a problem that it is needed to constantly collect the logs for the generated log sets, and a processing load is large. On the other hand, in the apparatus disclosed in WO 2022-091754 A1, since the logs are collected only when an anomaly is detected, the problem that the processing load is large can be solved.

However, in the apparatus disclosed in WO 2022-091754 A1, since the object is the in-vehicle network, a system that can be coped with is limited. The above-described computer system has a configuration different from that of the in-vehicle network, and has a configuration including a plurality of servers serving as hosts and terminals connected to the hosts. Therefore, the apparatus disclosed in WO 2022-091754 A1 has a problem that it is difficult to specify the attack route in the above-described computer system and it is not possible to collect the logs related to the attack.

An example of an object of the present disclosure is to improve collection efficiency of logs from a computer system.

In order to achieve the above object, an information processing apparatus in one aspect of the present disclosure includes
a related log selection unit that specifies an attack path related to a security alert and specifies a log related to the specified attack path in a computer system including hosts, and
a related log instruction unit that instructs the host that handles the specified log to store the specified log.

In order to achieve the above object, an information processing method in one aspect of the present disclosure includes
a related log selection step of specifying an attack path related to a security alert and specifying a log related to the specified attack path in a computer system including hosts, and
a related log instruction step of instructing the host that handles the specified log to store the specified log.

In order to achieve the above object, a computer-readable recording medium in one aspect of the present disclosure records a program including a command for causing
a computer to execute
a related log selection step of specifying an attack path related to a security alert and specifying a log related to the specified attack path in a computer system including hosts, and
a related log instruction step of instructing the host that handles the specified log to store the specified log.

As described above, according to the present disclosure, it is possible to improve collection efficiency of logs from a computer system.

### BRIEF DESCRIPTION OF THE DRAWINGS

FIG. 1 is a configuration diagram illustrating a schematic configuration of a first example of an information processing apparatus;

FIG. 2 is a configuration diagram specifically illustrating the configuration of the first example of the information processing apparatus;

FIG. 3 is a diagram schematically illustrating a process when a computer system is subjected to a cyberattack;

FIG. 4 is a diagram illustrating an example of attack path information prepared in advance;

FIG. 5 is a flowchart illustrating an operation of the first example of the information processing apparatus;

FIG. 6 is a diagram illustrating an example of an alert output from the computer system and an example of the attack path information;

FIG. 7 is a configuration diagram specifically illustrating a configuration of a second example of the information processing apparatus;

FIG. 8 is a diagram illustrating an example of information stored in a storage unit in the second example of the information processing apparatus;

FIG. 9 is a flowchart illustrating an operation of the second example of the information processing apparatus;

FIG. 10 is a diagram illustrating an example of the alert output from the computer system and an example of the information stored in the storage unit; and

FIG. 11 is a block diagram illustrating an example of a computer that achieves the information processing apparatuses in the first to third example embodiments.

### EXAMPLE EMBODIMENT

### First Example Embodiment

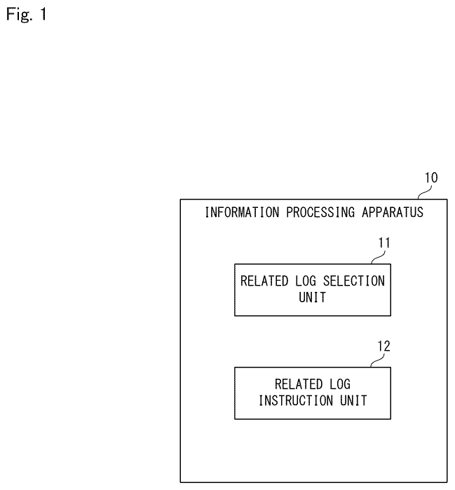

Hereinafter, an information processing apparatus, an information processing method, and a program in a first example embodiment will be described with reference to FIGS. 1 to 6.

### Apparatus Configuration

First, a schematic configuration of a first example of the information processing apparatus will be described with reference to FIG. 1. FIG. 1 is a configuration diagram illustrating the schematic configuration of the first example of the information processing apparatus.

An information processing apparatus 10 illustrated in FIG. 1 is a log analysis support apparatus for supporting analysis of logs in a computer system. As illustrated in FIG. 1, the information processing apparatus 10 includes a related log selection unit 11 and a related log instruction unit 12.

First, the related log selection unit 11 specifies an attack path related to a security alert in the computer system including hosts. Next, the related log selection unit 11 specifies logs related to the specified attack path. The related log instruction unit 12 instructs hosts that handle the specified logs to store the specified logs.

In this manner, since the information processing apparatus 10 specifies the attack path by using the security alert as a trigger and instructs storage of the logs related to the attack path, a processing load needed for acquisition of the logs is reduced. Since the information processing apparatus 10 can instruct the hosts constituting the computer system to store the logs, it is possible to improve collection efficiency of the logs from the computer system.

Here, the “security alert” means information indicating an occurrence situation of an attack. In particular, in the first example embodiment, the security alert is information indicating a possibility that the attack has occurred in the computer system. The attack path is information indicating a series of attack routes or a flow of attack procedures from intrusion into the computer system to achievement of a goal of attacking.

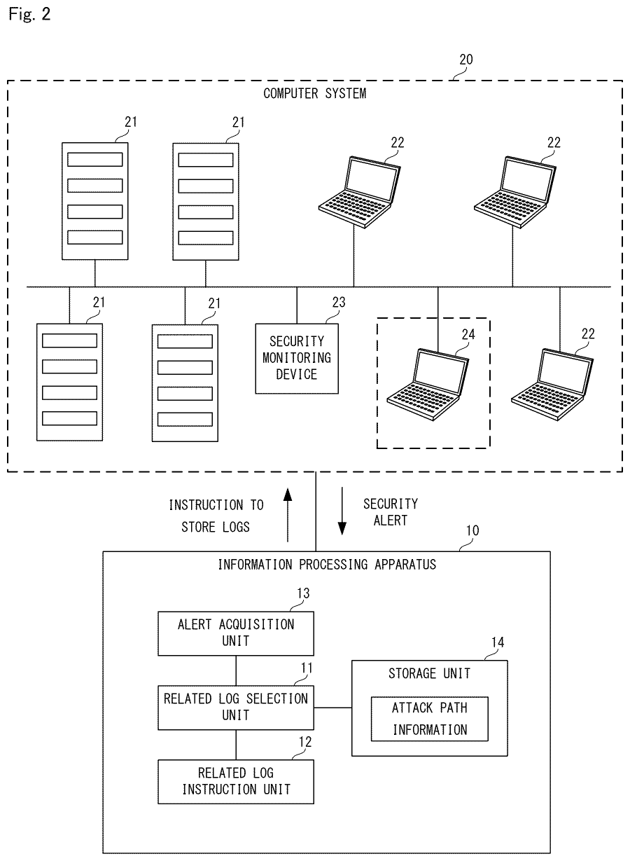

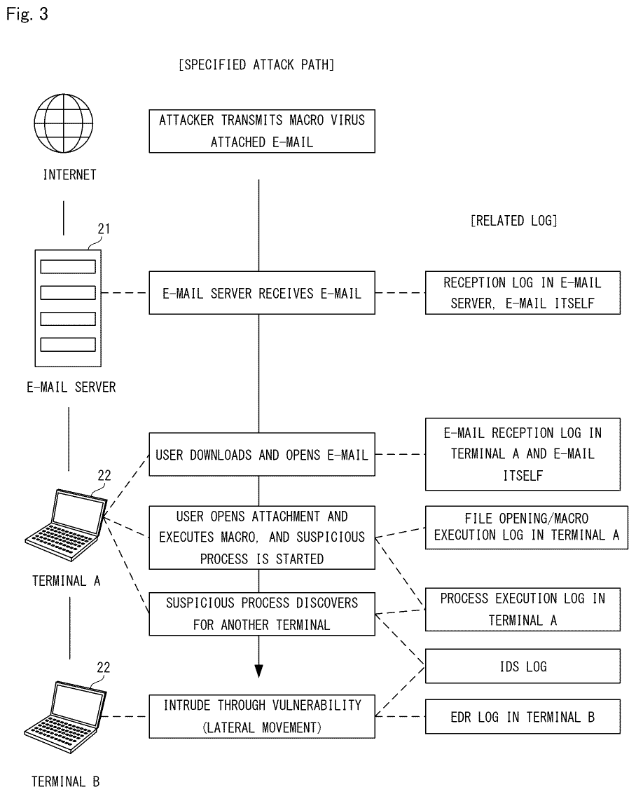

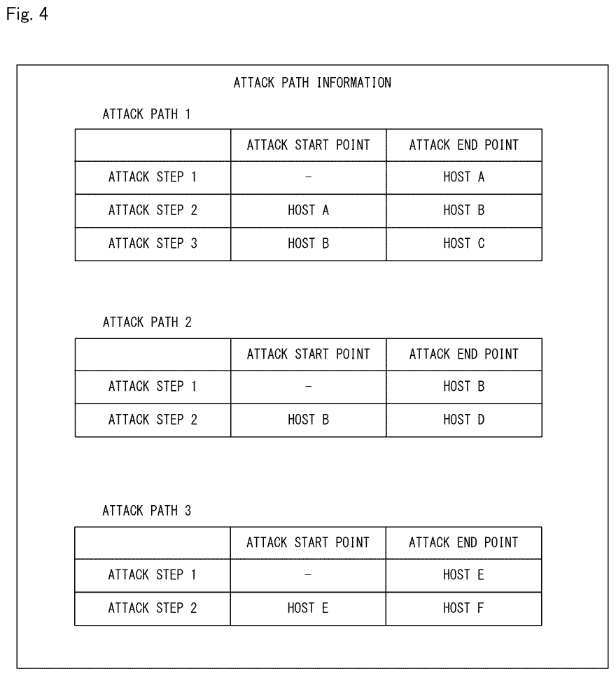

Subsequently, a configuration and a function of the information processing apparatus 10 will be specifically described with reference to FIGS. 2 to 4. FIG. 2 is a configuration diagram specifically illustrating the configuration of the first example of the information processing apparatus. FIG. 3 is a diagram schematically illustrating a process when the computer system is subjected to a cyberattack. FIG. 4 is a diagram illustrating an example of attack path information prepared in advance.

As illustrated in FIG. 2, the information processing apparatus 10 includes an alert acquisition unit 13 and a storage unit 14 in addition to the related log selection unit 11 and the related log instruction unit 12 illustrated in FIG. 1. As illustrated in FIG. 2, the information processing apparatus 10 is connected to a computer system 20 in which logs are to be analyzed via a network or the like in such a way as to be able to perform data communication.

The computer system 20 includes a plurality of hosts 21, a plurality of terminals 22, and a security monitoring device 23. In the example of FIG. 2, examples of the host 21 include a server device that provides a service to the terminal 22, such as an e-mail server or a file server. The computer system 20 is also connected to a terminal 24 of an administrator.

The security monitoring device 23 monitors situations and communication contents of the hosts 21 and the terminals 22, detects abnormal and suspicious behavior, and generates a security alert based on a detection result. The security monitoring device 23 then outputs the generated security alert to the terminal 24 of the administrator of the computer system 20, and notifies the administrator of the security alert. The security alert includes information indicating the host 21 that has been subjected to an attack (for example, a host name, an identifier of a host, and the like).

Here, an operation of the security monitoring device 23 will be described with reference to FIG. 3. First, as illustrated in FIG. 3, a cyberattack on the computer system 20 is performed by, for example, an e-mail to which a file including an illegal macro is attached. The host 21 serving as the e-mail server then receives the transmitted e-mail. Next, in the terminal 22, a user downloads and opens the e-mail. In the terminal 22, when the user opens the attachment and executes the macro, a suspicious process is started. Thereafter, in the terminal 22, the suspicious process discovers for another terminal 22 and executes an attack. As a result, intrusion into the another terminal 22 starts.

In FIG. 3, the right side illustrates an example of logs generated by the host 21 and the terminals 22 of the computer system 20. The security monitoring device 23 monitors these logs. For example, in a case where a “file opening/macro execution log in terminal A” is detected, the security monitoring device 23 generates a security alert and outputs the security alert.

The alert acquisition unit 13 acquires the security alert output from the security monitoring device 23. In a case where the administrator of the computer system 20 directly transmits the security alert to the information processing apparatus 10 via the terminal 24, the alert acquisition unit 13 acquires the transmitted security alert. The alert acquisition unit 13 outputs the acquired security alert to the related log selection unit 11.

The storage unit 14 stores attack path information created in advance by the administrator of the computer system 20, or the like. As illustrated in FIG. 4, the attack path information includes information related to attack steps for each attack path assumed by the administrator or the like. The information related to the attack steps includes an attack start point and an attack end point for each attack step constituting the corresponding attack path. The attack start point and the attack end point are usually specified by information indicating the related host.

In the first example embodiment, the related log selection unit 11 first specifies the host that has been subjected to the attack from the security alert acquired by the alert acquisition unit 13, and specifies an attack path related to the specified host.

Specifically, the related log selection unit 11 first specifies the host 21 that has been subjected to the attack based on the information indicating the host 21 included in the security alert. Next, the related log selection unit 11 collates the specified host with the attack path information (see FIG. 4) stored in the storage unit 14, and specifies the attack path related to the specified host.

Subsequently, the related log selection unit 11 specifies attack steps included in the specified attack path from the attack path information, and specifies a log related to the attack path for each of the specified attack steps.

Specifically, the related log selection unit 11 specifies, from the attack path information (see FIG. 4), the host 21 related to each attack step constituting the specified attack path, that is, the host that has become an attack start point or an attack end point. The related log selection unit 11 then specifies a log handled by the specified host 21 as the log related to the specified attack path. Here, examples of the log handled by the host 21 include a log transmitted to the host 21 in addition to a log generated by the host 21.

The related log instruction unit 12 instructs the host 21 that handles the log specified as being related to the attack path to store the log specified as being related to the attack path. Specifically, the related log instruction unit 12 instructs the host 21 specified by the related log selection unit 11 to store the log handled by the host 21. The related log instruction unit 12 can also instruct acquisition of a log other than the log generated by the host 21 itself.

In the case of instructing the host 21, the related log instruction unit 12 transmits, to the host 21, data including a type of the specified log and the instruction to store the specified log. By receiving the data, the host 21 stores the log.

In the computer system 20, a log management system or a security information and event management (SIEM) system may be introduced. In such a case, since the log of each host is integrally managed by the log management system or the SIEM system, the related log instruction unit 12 can instruct the log management system or the SIEM system to store the log in each host 21.

### Apparatus Operation

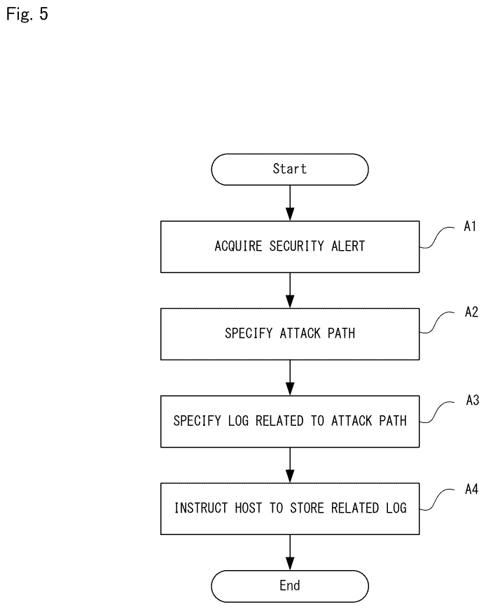

Next, an operation of the information processing apparatus 10 will be described with reference to FIG. 5. FIG. 5 is a flowchart illustrating the operation of the first example of the information processing apparatus. In the following description, FIGS. 1 to 4 will be appropriately referred to. In the first example embodiment, the information processing method is performed by operating the information processing apparatus 10. Therefore, in the first example embodiment, description of the information processing method is replaced with the following description of the operation of the information processing apparatus 10.

As illustrated in FIG. 5, first, the alert acquisition unit 13 acquires a security alert output from the security monitoring device 23 (step A1). In step A1, the alert acquisition unit 13 outputs the acquired security alert to the related log selection unit 11.

Next, the related log selection unit 11 specifies the host 21 that has been subjected to an attack from the security alert, and specifies an attack path related to the specified host 21 (step A2).

Specifically, in step A2, the related log selection unit 11 specifies the host 21 that has been subjected to the attack based on information indicating the host 21 included in the security alert. The related log selection unit 11 then collates the specified host with the attack path information (see FIG. 4) stored in the storage unit 14, and specifies the attack path related to the specified host.

Next, the related log selection unit 11 specifies a log related to the specified attack path (step A3).

Specifically, in step A3, the related log selection unit 11 specifies, from the attack path information (see FIG. 4), an attack start point and an attack end point of each attack step constituting the attack path specified in step A2. The related log selection unit 11 then specifies a log handled by the host 21 serving as the attack start point or the attack end point as the log related to the specified attack path.

Next, the related log instruction unit 12 instructs the host that handles the log specified in step A3 to store the specified log (step A4).

Specifically, in step A4, the related log instruction unit 12 instructs the host 21 that handles the log specified in step A3 to store the log handled by the host 21.

In this manner, when the security alert is output by the computer system 20, the information processing apparatus 10 specifies the attack path by using the security alert as a trigger, further specifies the log related to the attack path, and instructs storage of the log. Therefore, the processing load for acquisition of the logs is reduced as compared with a case where the logs are constantly collected. Since the information processing apparatus 10 can instruct the hosts 21 constituting the computer system to store the logs, it is possible to improve the collection efficiency of the logs from the computer system.

### Specific Example

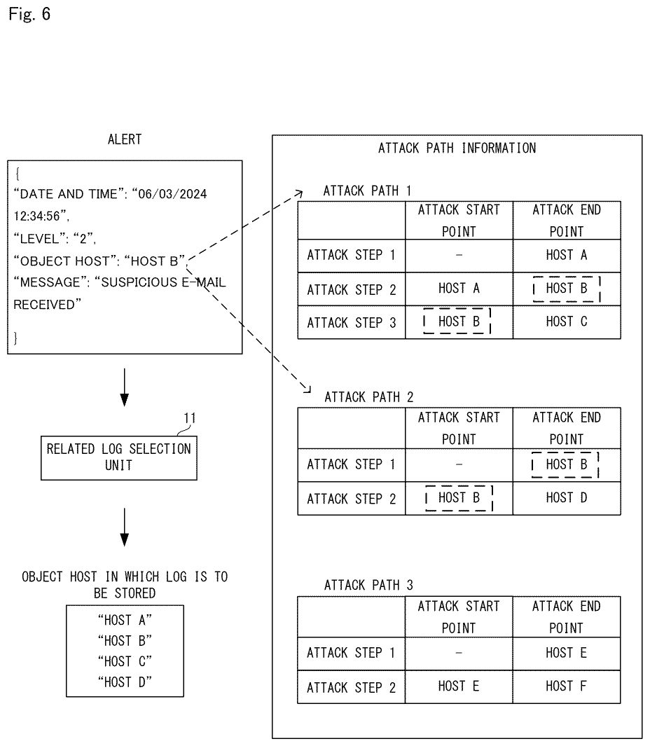

Here, a specific example of the processing in the information processing apparatus 10 will be described with reference to FIG. 6. FIG. 6 is a diagram illustrating an example of the alert output from the computer system and an example of the attack path information. The attack path information illustrated in FIG. 6 is the same as the attack path information illustrated in FIG. 4.

First, it is assumed that the alert acquisition unit 13 acquires the alert illustrated in FIG. 6. In this case, the related log selection unit 11 specifies a “host B” as the host 21 that has been subjected to the attack based on the information indicating the host 21 included in the security alert. Next, the related log selection unit 11 collates the “host B” with the attack path information (see FIG. 4), and specifies an “attack path 1” and an “attack path 2” as attack paths related to the specified “host B”.

The related log selection unit 11 also specifies an attack start point and an attack end point of each attack step constituting the specified “attack path 1” and “attack path 2”. In the example of FIG. 6, the related log selection unit 11 specifies a “host A”, the “host B”, and a “host C” from the “attack path 1”, and specifies the “host B” and a “host D”from the “attack path 2”.

Thereafter, the related log instruction unit 12 instructs the “host A”, the “host B”, the “host C”, and the “host D” to store logs handled by the hosts. In this manner, in a case where the alert illustrated in FIG. 6 is output, the hosts A to D are instructed to store the logs.

### Program

In the first example embodiment, examples of the program include a program for causing a computer to execute steps A1 to A4 illustrated in FIG. 5. When the program is installed and executed in the computer, the information processing apparatus 10 and the information processing method can be achieved. In this case, a processor of the computer functions as the related log selection unit 11, the related log instruction unit 12, and the alert acquisition unit 13, and performs processing.

The storage unit 14 may be achieved by storing data files in a storage device such as a hard disk provided in the computer, or may be achieved by a storage device of another computer.

The program in the first example embodiment may be executed by a computer system constructed by a plurality of computers. In this case, for example, each computer may function as any one of the related log selection unit 11, the related log instruction unit 12, and the alert acquisition unit 13.

### Second Example Embodiment

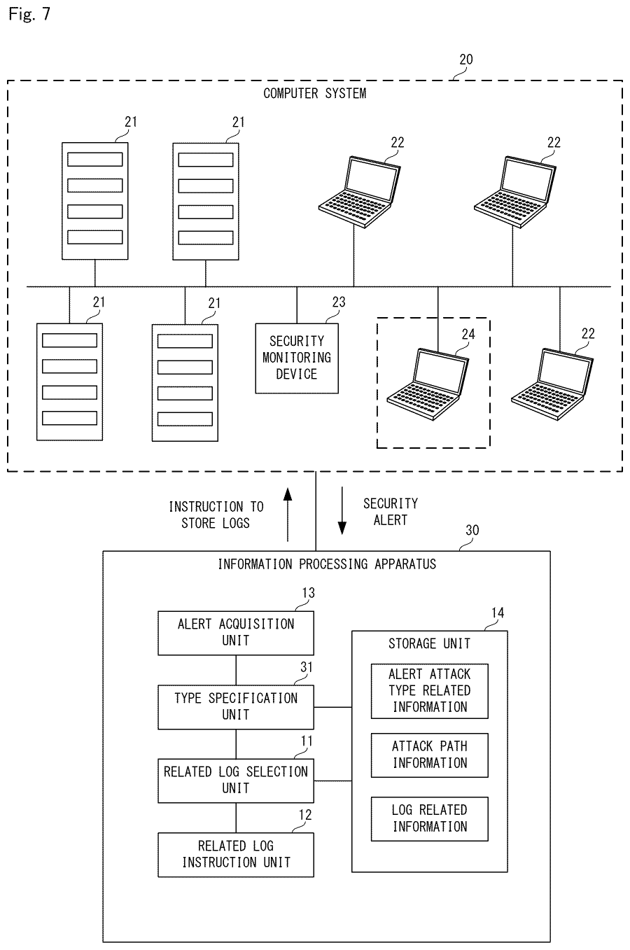

Next, an information processing apparatus, an information processing method, and a program in a second example embodiment will be described with reference to FIGS. 7 to 9.

### Apparatus Configuration

First, a configuration of a second example of the information processing apparatus will be described with reference to FIG. 7. FIG. 7 is a configuration diagram specifically illustrating the configuration of the second example of the information processing apparatus.

Similarly to the information processing apparatus 10 illustrated in FIGS. 1 and 2, an information processing apparatus 30 illustrated in FIG. 7 is a log analysis support apparatus for supporting analysis of logs in a computer system. As illustrated in FIG. 7, similarly to the information processing apparatus 10, the information processing apparatus 30 includes a related log selection unit 11, a related log instruction unit 12, an alert acquisition unit 13, and a storage unit 14.

However, the information processing apparatus 30 is different from the information processing apparatus 10 in that the information processing apparatus 30 further includes a type specification unit 31 in addition to the related log selection unit 11, the related log instruction unit 12, the alert acquisition unit 13, and the storage unit 14. Information stored in the storage unit 14 is also different from that of the information processing apparatus 10. Hereinafter, differences from the first example embodiment will be mainly described.

First, also in the second example embodiment, a security alert is information indicating a possibility that an attack has occurred in the computer system, as in the first example embodiment. However, in the second example embodiment, the security alert also includes information indicating an attack type, specifically, an alert type, in addition to information indicating a host 21 that has been subjected to the attack (for example, an identifier of the host). The type specification unit 31 specifies the attack type from the security alert.

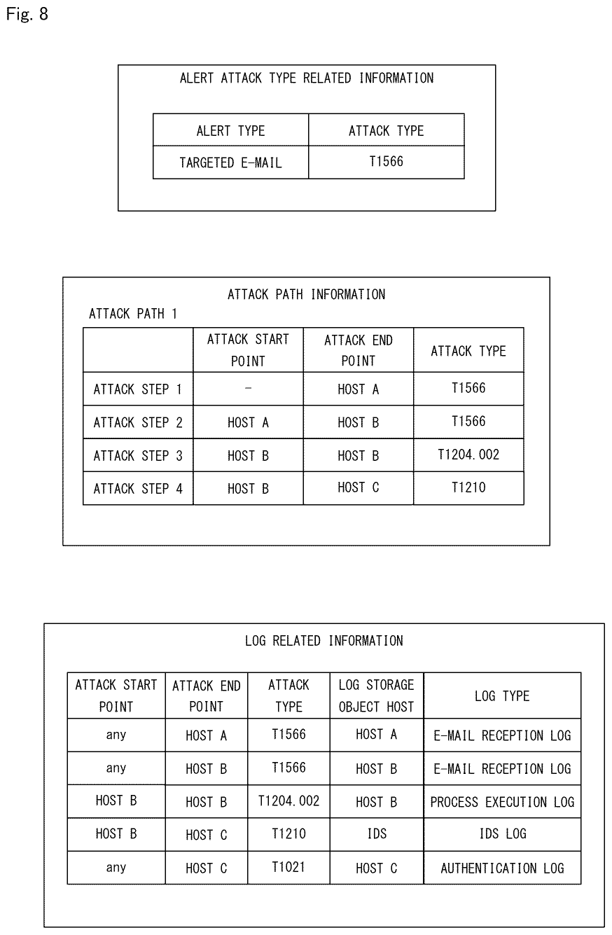

As illustrated in FIG. 8, the storage unit 14 stores alert attack type related information and log related information in addition to attack path information also described in the first example embodiment. FIG. 8 is a diagram illustrating an example of the information stored in the storage unit in the second example of the information processing apparatus.

As illustrated in FIG. 8, the alert attack type related information is information indicating a correspondence relationship between the alert type and the attack type included in the security alert. By specifying the alert type, the attack type is specified.

Also in the example of FIG. 8, the attack path information includes information related to attack steps for each attack path assumed by an administrator or the like. However, in the example of FIG. 8, the information related to the attack steps includes the attack type for each attack step in addition to an attack start point and an attack end point for each attack step.

In the example of FIG. 8, the attack type is indicated by a number set in MITRE ATT&CK (registered trademark). Specific examples of the numbers are indicated below.
T1566: Phishing
T1204.002: User Execution: Malicious File
T1210: Exploitation of Remote Services
T1021: Remote Services

The attack type may also be indicated at a strategy level such as “initial access” or “lateral movement”, or may also be indicated at a tactical level such as “phishing” or “exploitation of remote services”. The attack type may also be indicated by a name of a tool used for an attack, such as “nmap” or “PowerShell (registered trademark)”, a CVE number used for an attack, or a name of vulnerability. In addition, the attack type may be indicated by an identifier of an audit item in a security audit.

As illustrated in FIG. 8, the log related information is information including a related log type and a host that stores the related log for each combination of the attack start point, the attack end point, and the attack type. For example, in a case where the attack end point is a host A and the attack type is T1566 (Phishing), the related log is an e-mail reception log, and a host that stores the e-mail reception log is the host A.

The type specification unit 31 specifies the attack type from the security alert. Specifically, the type specification unit 31 specifies the alert type from the security alert, collates the specified alert type with the alert attack type related information, and specifies the attack type.

Also in the second example embodiment, the related log selection unit 11 specifies the host 21 that has been subjected to the attack based on the information indicating the host 21 included in the security alert, as in the first example embodiment.

Subsequently, the related log selection unit 11 specifies an attack path related to the specified host and the attack type specified by the type specification unit 31, and specifies a related host and a related log for each step included in the specified attack path.

Specifically, the related log selection unit 11 collates the specified host and attack type with the attack path information, and specifies the attack path related to these. Next, the related log selection unit 11 specifies a set of the attack start point, the attack end point, and the attack type related to each attack step constituting the specified attack path. Thereafter, the related log selection unit 11 collates the specified set with the log related information, and specifies the related log type and the host that stores the related log.

The related log instruction unit 12 instructs the specified related host to store the specified related log. Specifically, the related log instruction unit 12 instructs the host specified from the log related information to store the log of the log type specified from the log related information.

Also in the second example embodiment, in a computer system 20, a log management system or a security information and event management (SIEM) system may be introduced. In such a case, since the log of each host is integrally managed by the log management system or the SIEM system, the related log instruction unit 12 can instruct the log management system or the SIEM system to store the log in each host 21, also in the second example embodiment.

### Apparatus Operation

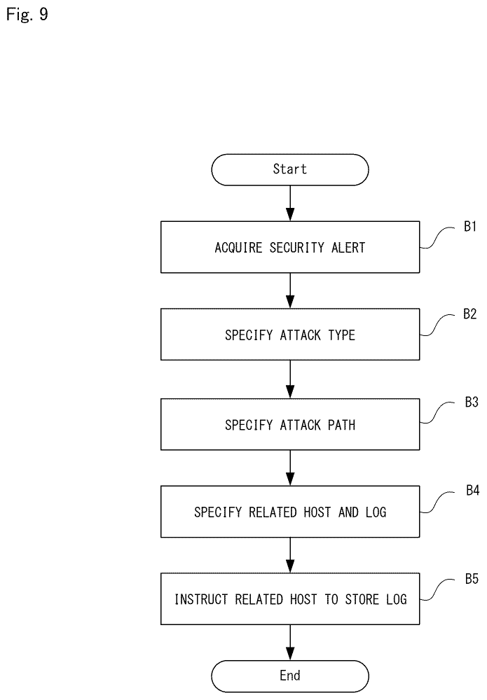

Next, an operation of the information processing apparatus 30 will be described with reference to FIG. 9. FIG. 9 is a flowchart illustrating the operation of the second example of the information processing apparatus. In the following description, FIGS. 7 and 8 will be appropriately referred to. In the second example embodiment, the information processing method is performed by operating the information processing apparatus 30. Therefore, in the second example embodiment, description of the information processing method is replaced with the following description of the operation of the information processing apparatus 30.

As illustrated in FIG. 9, first, the alert acquisition unit 13 acquires a security alert output from the security monitoring device 23 (step B1). In step B1, the alert acquisition unit 13 outputs the acquired security alert to the related log selection unit 11 and the type specification unit 31.

Next, the type specification unit 31 specifies an attack type from the security alert (step B2).

Specifically, the type specification unit 31 specifies an alert type from the security alert, collates the specified alert type with the alert attack type related information (see FIG. 8), and specifies the attack type.

Next, the related log selection unit 11 specifies the host 21 that has been subjected to an attack from the security alert, and specifies an attack path related to the specified host 21 and the attack type specified in step B2 (step B3).

Specifically, in step B3, the related log selection unit 11 collates the specified host and attack type with the attack path information, and specifies the attack path related to these.

Next, the related log selection unit 11 specifies a related host and a related log for each step included in the attack path specified in step B3 (step B4).

Specifically, in step B4, the related log selection unit 11 specifies, by using the attack path information, a set of an attack start point, an attack end point, and the attack type related to each attack step constituting the attack path specified in step B3. Thereafter, the related log selection unit 11 collates the specified set with the log related information, and specifies the related log type and the host that stores the related log.

Next, the related log instruction unit 12 instructs the related host specified in step B4 to store the related log specified in step B4 (step B5).

Specifically, in step B5, the related log instruction unit 12 instructs the host specified from the log related information to store the log of the log type specified from the log related information.

In this manner, similarly to the information processing apparatus 10, when the security alert is output by the computer system 20, the information processing apparatus 30 specifies the attack path by using the security alert as a trigger, further specifies the log related to the attack path, and instructs storage of the log. Therefore, a processing load for acquisition of the logs is reduced as compared with a case where the logs are constantly collected. Since the information processing apparatus 30 can instruct the hosts 21 constituting the computer system to store the logs, it is possible to improve collection efficiency of the logs from the computer system.

In the second example embodiment, the attack type can be specified from the security alert, and the type of log to be stored can be selected according to the attack type. Therefore, according to the second example embodiment, the collection efficiency of the logs can be further improved.

In a case where the security alert includes information indicating the log type instead of the information indicating the attack type or in addition to the information indicating the attack type, the type specification unit 31 can specify the log type from the security alert. In this case, the related log selection unit 11 specifies the attack path related to the specified host and the log type specified by the type specification unit 31, and specifies the related host and the related log for each step included in the specified attack path.

In the above case, in the attack path information, the alert attack type related information, and the log related information, a field of the “log type” is provided instead of a field of the attack type or in addition to a field of the attack type.

### Specific Example

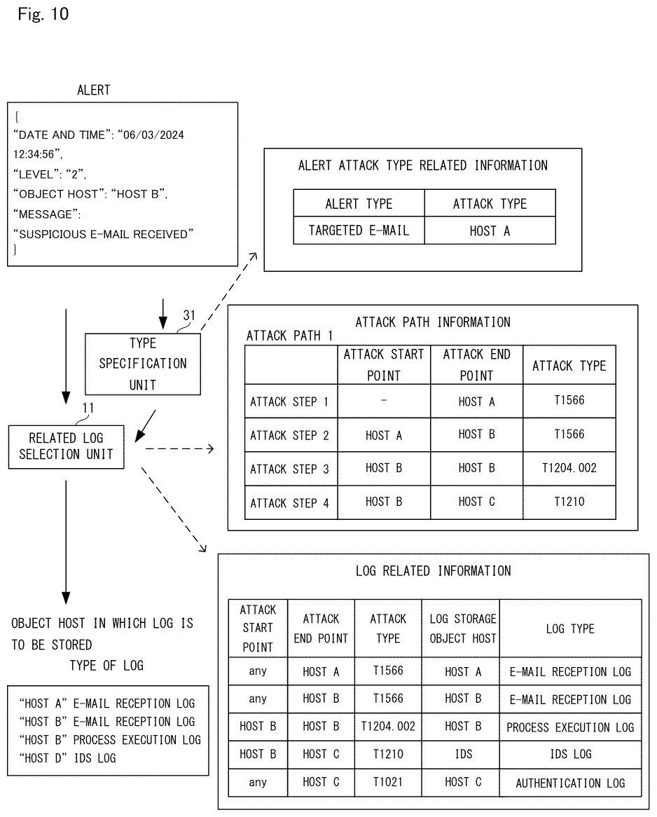

Here, a specific example of the processing in the information processing apparatus 30 will be described with reference to FIG. 10. FIG. 10 is a diagram illustrating an example of the alert output from the computer system and an example of the information stored in the storage unit. The information illustrated in FIG. 10 is the same as the information illustrated in FIG. 8.

First, it is assumed that the alert acquisition unit 13 acquires the alert illustrated in FIG. 10. In this case, the type specification unit 31 specifies a “targeted attack e-mail” as the alert type from the security alert. The type specification unit 31 then collates the specified alert type “targeted attack e-mail” with the alert attack type related information, and specifies the attack type “T1566”.

Next, the related log selection unit 11 specifies a “host B” as the host 21 that has been subjected to the attack based on the information indicating the host 21 included in the security alert.

Next, the related log selection unit 11 collates the “host B” and the attack type “T1566” with the attack path information (see FIG. 4), and specifies an “attack step 2” of an “attack path 1” in which the “host B” and the attack type “T1566” match. The related log selection unit 11 then specifies the “attack path 1” including the specified attack step 2 as an attack path related to the “host B”and the attack type “T1566”.

Next, the related log selection unit 11 specifies a set of a related attack start point, attack end point, and attack type in each attack step constituting the specified attack path 1. In the example of FIG. 10, the following sets are specified.
Attack Step 1:—, Host A, T1566
Attack Step 2: Host A, Host B, T1566
Attack Step 3: Host B, Host B, T1204.002
Attack Step 4: Host B, Host C, T1210

Thereafter, the related log selection unit 11 collates the specified sets with the log related information. Specifically, in the above set of the attack step 1, since there is no limitation on the attack start point, the attack end point is the host A, and the attack type is T1566, a log storage object host is the host A, and the log type is the e-mail reception log. Similarly, in the sets of the attack steps 2 to 4, the log storage object hosts and the log types are specified. As a result, the log storage object hosts and the log types are as follows.
Host A: E-mail reception log
Host B: E-mail reception log
Host B: Process execution log
Host C: IDS log

Thereafter, the related log instruction unit 12 specifies the log types for the “host A”, the “host B”, and the “host C”, and instructs the “host A”, the “host B”, and the “host C” to store the logs. In this manner, in a case where the alert illustrated in FIG. 10 is output, the hosts A to C are instructed to store the logs.

### Program

In the second example embodiment, examples of the program include a program for causing a computer to execute steps B1 to B5 illustrated in FIG. 9. When the program is installed and executed in the computer, the information processing apparatus 30 and the information processing method can be achieved. In this case, a processor of the computer functions as the related log selection unit 11, the related log instruction unit 12, the alert acquisition unit 13, and the type specification unit 31, and performs processing.

The storage unit 14 may be achieved by storing data files in a storage device such as a hard disk provided in the computer, or may be achieved by a storage device of another computer.

The program in the second example embodiment may be executed by a computer system constructed by a plurality of computers. In this case, for example, each computer may function as any one of the related log selection unit 11, the related log instruction unit 12, the alert acquisition unit 13, and the type specification unit 31.

### Third Example Embodiment

Next, an information processing apparatus, an information processing method, and a program in a third example embodiment will be described.

### Apparatus Configuration

In the third example embodiment, the information processing apparatus has a configuration similar to that of the information processing apparatus 10 illustrated in FIGS. 1 and 2. Therefore, in the following description, FIGS. 1 and 2 will be referred to. However, in the third example embodiment, intelligence information provided for a cyberattack is used as a security alert. Therefore, there are differences from the first example embodiment in a function of each unit. Hereinafter, differences from the first example embodiment will be mainly described.

In the third example embodiment, an alert acquisition unit 13 acquires intelligence information as a security alert from the outside instead of a security alert generated by a security monitoring device 23. The intelligence information is, for example, information referred to as a threat report, vulnerability information, and an incident report. The intelligence information may be described in a natural language, or may be structured in a structured threat information expression (STIX) format or the like, for example.

The intelligence information includes information indicating an attack type. As in the second example embodiment, the attack type may be indicated by a number set in MITRE ATT&CK. The attack type may also be indicated at a strategy level such as “initial access” or “lateral movement”, or may also be indicated at a tactical level such as “phishing” or “exploitation of remote services”. The attack type may also be indicated by a name of a tool used for an attack, such as “nmap” or “PowerShell (registered trademark)”, a CVE number used for an attack, or a name of vulnerability. In addition, the attack type may be indicated by an identifier of an audit item in a security audit.

A storage unit 14 stores attack path information similar to the attack path information illustrated in FIG. 8. Also in the third example embodiment, the attack path information is configured for each attack path. Each attack path includes information related to a plurality of attack steps, and the information related to the attack steps includes an attack start point, an attack end point, and the attack type for each attack step.

In the third example embodiment, a related log selection unit 11 specifies the attack type from the security alert, and specifies the attack path related to the specified attack type. Specifically, the related log selection unit 11 collates the specified attack type with the attack path information, specifies the matching attack step, and then specifies the attack path having the specified attack step.

Next, the related log selection unit 11 specifies the host 21 that has become the attack start point or the attack end point in each attack step constituting the specified attack path. The related log selection unit 11 then specifies a log handled by the specified host 21 as the log related to the specified attack path.

In a case where the storage unit 14 stores the log related information illustrated in FIG. 8, the related log selection unit 11 can specify a related log type in addition to the host that stores the log by using the log related information.

### Apparatus Operation

Also in the third example embodiment, the information processing apparatus operates along steps A1 to A4 illustrated in FIG. 5. Specifically, the information processing apparatus executes acquisition of a security alert, that is, intelligence information (step A1), specification of an attack path (step A2), specification of a log related to the attack path (step A3), and instruction to store the log (step A4). The information processing method is performed by operating the information processing apparatus.

In the third example embodiment, when the intelligence information is transmitted, the information processing apparatus specifies the attack path by using the intelligence information as a trigger, further specifies the log related to the attack path, and instructs storage of the log. Therefore, also in the third example embodiment, a processing load for acquisition of the logs is reduced as compared with a case where the logs are constantly collected. Since the information processing apparatus can instruct hosts 21 constituting a computer system to store the logs, it is possible to improve collection efficiency of the logs from the computer system.

### Program

Also in the third example embodiment, examples of the program include a program for causing a computer to execute steps A1 to A4 illustrated in FIG. 5. When the program is installed and executed in the computer, the information processing apparatus and the information processing method can be achieved. In this case, a processor of the computer functions as the related log selection unit 11, a related log instruction unit 12, and the alert acquisition unit 13, and performs processing.

The storage unit 14 may be achieved by storing data files in a storage device such as a hard disk provided in the computer, or may be achieved by a storage device of another computer.

The program in the third example embodiment may also be executed by a computer system constructed by a plurality of computers. In this case, for example, each computer may function as any one of the related log selection unit 11, the related log instruction unit 12, and the alert acquisition unit 13.

### Modifications

Hereinafter, modifications common to the first to third example embodiments will be described.

The related log instruction unit 12 may specify a storage condition of the logs for the host 21 specified by the related log selection unit 11. Examples of the storage condition of the logs include a storage period of the logs. The related log instruction unit 12 can specify a storage period longer than a normal storage period. The storage period may be set by the administrator or the like.

Examples of other storage conditions of the logs include a range of the logs to be stored (log level, event ID, facility in a syslog), the number of logs to be backed up, and a backup location of the logs (necessity of remote backup, offline backup, and the like).

In a case where the security alert includes information indicating a level of urgency, the related log instruction unit 12 can specify the level of urgency from the security alert and set the above-described storage condition of the logs according to the specified level of urgency.

For example, in a case where the level of urgency included in the security alert is equal to or more than a certain level, the related log instruction unit 12 may specify a longer storage period or may specify storage of the logs in a wider range. In a case where the level of urgency included in the security alert is equal to or more than the certain level, the related log instruction unit 12 may specify the number of logs to be backed up to be made larger or may specify the backed-up logs to be stored in a safer location.

Examples of the log instructed to be stored include an authentication log, an access log, an endpoint detection and response (EDR) log, an event log, a command history, a syslog, a DHCP log, a network connection log, an NDR log, an IDS log, an IPS log, a UTM log, a firewall log, packet capture, a proxy log, a SIEM log, an e-mail transmission/reception log, an e-mail header, an e-mail body, an e-mail attachment, an email filter log, a sandbox log, an artifact, a memory dump, a disk image, a file, a folder, a directory, a trash box, an alternative stream, a registry, an running process, a screenshot, a config file, a startup, a cron job, a browser history, a cookie, a cache, a crash dump, a Master File Table, a journal, Recent Files, Jump Lists, Shell Bags, Shortcut, Prefetch, Office Recent Files, Volume shadow, and an account. The log instructed to be stored may be a combination of these. The log instructed to be stored may be other than these, and is not limited.

The host may be a physical device, or may be a virtual machine, a network, a container, a process, or a combination of these.

The related log selection unit 11 can derive the attack path from the security alert instead of specifying the attack path by using the attack path information (see FIG. 4) stored in the storage unit 14. However, in this case, various technologies for deriving the attack path, such as attack tree analysis and FTA, are used.

In the present disclosure, the computer system 20 in which the logs are to be analyzed may include a plurality of physical devices connected via a network, or may be a system in which some or all functions are implemented on a cloud computer.

In the above-described example, the security alert is output when the security monitoring device 23 constituting the computer system 20 detects suspicious behavior by monitoring communication in the network, but the present disclosure is not limited to such an aspect.

In the present disclosure, the security alert may be output by anti-virus software installed in each host or EDR. In a case where the log management system is introduced into the computer system 20, the log management system collects the log generated by each host and communication logs of the network, and outputs the security alert when detecting suspicious behavior from the logs. In a case where the SIEM system is introduced in the computer system 20, the SIEM system outputs the security alert. The security alert may be manually output by the administrator of the computer system 20.

### Physical Configuration

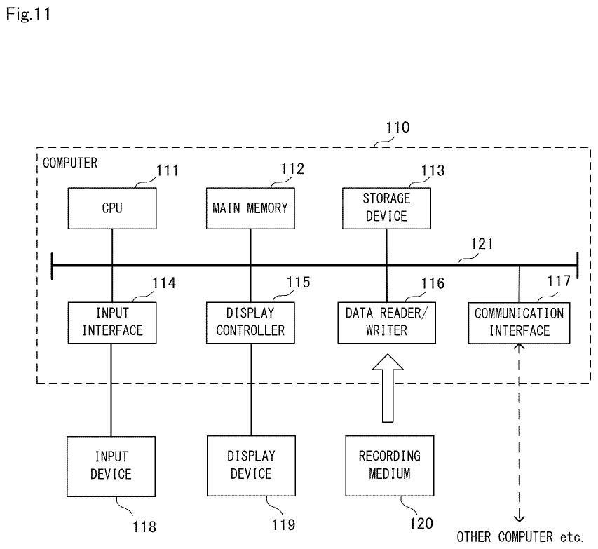

Here, a computer that achieves the information processing apparatuses by executing the programs in the first to third example embodiments will be described with reference to FIG. 11. FIG. 11 is a block diagram illustrating an example of the computer that achieves the information processing apparatuses in the first to third example embodiments.

As illustrated in FIG. 11, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other.

The computer 110 may include a graphics processing unit (GPU) or a field-programmable gate array (FPGA) in addition to the CPU 111 or instead of the CPU 111. In this aspect, the GPU or the FPGA may execute the programs in the example embodiments.

The CPU 111 loads the program in the example embodiment, which is stored in the storage device 113 and includes codes, into the main memory 112, and executes each code in a predetermined order to perform various operations. The main memory 112 is typically a volatile storage device such as a dynamic random access memory (DRAM).

The program in the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) and Secure Digital (SD), a magnetic recording medium such as a flexible disk, or an optical recording medium such as a compact disk read only memory (CD-ROM).

The information processing apparatus in the example embodiment can also be achieved by using hardware related to each unit, for example, an electronic circuit, instead of the computer in which the program is installed. A part of the information processing apparatus may be achieved by a program, and the remaining part may be achieved by hardware. In the example embodiments, the computer is not limited to the computer illustrated in FIG. 11.

Some or all of the above-described example embodiments can be expressed by (Supplementary Note 1) to (Supplementary Note 24) described below, but are not limited to the following description.

### Supplementary Note 1

An information processing apparatus including:
a related log selection unit that specifies an attack path related to a security alert and specifies a log related to the specified attack path in a computer system including hosts; and
a related log instruction unit that instructs the host that handles the specified log to store the specified log.

### Supplementary Note 2

The information processing apparatus according to Supplementary Note 1, in which
the security alert includes information indicating a host that has been subjected to an attack, and
the related log selection unit specifies the host that has been subjected to the attack from the security alert, and specifies the attack path related to the specified host.

### Supplementary Note 3

The information processing apparatus according to Supplementary Note 2, in which
the security alert further includes information indicating an attack type,
a type specification unit that specifies the attack type from the security alert is further included,
the related log selection unit specifies an attack path related to the specified host and the specified attack type, and specifies a related host and a related log for each step included in the specified attack path, and
the related log instruction unit instructs the specified related host to store the specified related log.

### Supplementary Note 4

The information processing apparatus according to Supplementary Note 1, in which
the security alert is intelligence information provided for a cyberattack and includes information indicating an attack type, and
the related log selection unit specifies the attack type from the security alert, and specifies the attack path related to the specified attack type.

### Supplementary Note 5

The information processing apparatus according to Supplementary Note 1, in which
the related log selection unit further specifies attack steps included in the specified attack path, and specifies the log related to the attack path for each of the specified attack steps.

### Supplementary Note 6

The information processing apparatus according to Supplementary Note 1, in which
the related log instruction unit further instructs a storage condition of the log for the host.

### Supplementary Note 7

The information processing apparatus according to Supplementary Note 6, in which
the security alert includes information indicating a level of urgency, and
the related log instruction unit specifies the level from the security alert, and sets the storage condition of the log according to the specified level.

### Supplementary Note 8

The information processing apparatus according to Supplementary Note 1, in which
the related log instruction unit transmits, to the host, data including a type of the specified log and the instruction to store the specified log.

### Supplementary Note 9

An information processing method including:
a related log selection step of specifying an attack path related to a security alert and specifying a log related to the specified attack path in a computer system including hosts; and
a related log instruction step of instructing the host that handles the specified log to store the specified log.

### Supplementary Note 10

The information processing method according to Supplementary Note 9, in which
the security alert includes information indicating a host that has been subjected to an attack, and
in the related log selection step, the host that has been subjected to the attack is specified from the security alert, and the attack path related to the specified host is specified.

### Supplementary Note 11

The information processing method according to Supplementary Note 10, in which
the security alert further includes information indicating an attack type,
a type specification step of specifying the attack type from the security alert is further included,
in the related log selection step, an attack path related to the specified host and the specified attack type is specified, and a related host and a related log are specified for each step included in the specified attack path, and
in the related log instruction step, the specified related host is instructed to store the specified related log.

### Supplementary Note 12

The information processing method according to Supplementary Note 9, in which
the security alert is intelligence information provided for a cyberattack and includes information indicating an attack type, and
in the related log selection step, the attack type is specified from the security alert, and the attack path related to the specified attack type is specified.

### Supplementary Note 13

The information processing method according to Supplementary Note 9, in which
in the related log selection step, attack steps included in the specified attack path are further specified, and the log related to the attack path is specified for each of the specified attack steps.

### Supplementary Note 14

The information processing method according to Supplementary Note 9, in which
in the related log instruction step, a storage condition of the log is further instructed for the host.

### Supplementary Note 15

The information processing method according to Supplementary Note 14, in which
the security alert includes information indicating a level of urgency, and in the related log instruction step, the level is specified from the security alert, and the storage condition of the log is set according to the specified level.

### Supplementary Note 16

The information processing method according to Supplementary Note 9, in which
in the related log instruction step, data including a type of the specified log and the instruction to store the specified log is transmitted to the host.

### Supplementary Note 17

A computer-readable recording medium recording a program including a command for causing a computer to execute:
a related log selection step of specifying an attack path related to a security alert and specifying a log related to the specified attack path in a computer system including hosts; and
a related log instruction step of instructing the host that handles the specified log to store the specified log.

### Supplementary Note 18

The computer-readable recording medium according to Supplementary Note 17, in which
the security alert includes information indicating a host that has been subjected to an attack, and
in the related log selection step, the host that has been subjected to the attack is specified from the security alert, and the attack path related to the specified host is specified.

### Supplementary Note 19

The computer-readable recording medium according to Supplementary Note 18, in which
the security alert further includes information indicating an attack type,
the program further includes a command for causing the computer to execute
a type specification step of specifying the attack type from the security alert,
in the related log selection step, an attack path related to the specified host and the specified attack type is specified, and a related host and a related log are specified for each step included in the specified attack path, and
in the related log instruction step, the specified related host is instructed to store the specified related log.

### Supplementary Note 20

The computer-readable recording medium according to Supplementary Note 17, in which
the security alert is intelligence information provided for a cyberattack and includes information indicating an attack type, and in the related log selection step, the attack type is specified from the security alert, and the attack path related to the specified attack type is specified.

### Supplementary Note 21

The computer-readable recording medium according to Supplementary Note 17, in which
in the related log selection step, attack steps included in the specified attack path are further specified, and the log related to the attack path is specified for each of the specified attack steps.

### Supplementary Note 22

The computer-readable recording medium according to Supplementary Note 17, in which
in the related log instruction step, a storage condition of the log is further instructed for the host.

### Supplementary Note 23

The computer-readable recording medium according to Supplementary Note 22, in which
the security alert includes information indicating a level of urgency, and in the related log instruction step, the level is specified from the security alert, and the storage condition of the log is set according to the specified level.

### Supplementary Note 24

The computer-readable recording medium according to Supplementary Note 17, in which
in the related log instruction step, data including a type of the specified log and the instruction to store the specified log is transmitted to the host.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

As described above, according to the present disclosure, it is possible to improve collection efficiency of logs from a computer system. The present disclosure is useful for various systems for combating cyberattacks.

1. An information processing apparatus comprising:
at least one memory storing instructions; and
at least one processor configured to execute the instructions to:
specify an attack path related to a security alert and specifies a log related to the specified attack path in a computer system including hosts; and
instruct the host that handles the specified log to store the specified log.

2. The information processing apparatus according to claim 1, wherein
the security alert includes information indicating a host that has been subjected to an attack, and
at least one processor specifies the host that has been subjected to the attack from the security alert, and specifies the attack path related to the specified host.

3. The information processing apparatus according to claim 2, wherein
the security alert further includes information indicating an attack type,
at least one processor specifies the attack type from the security alert is further included, specifies an attack path related to the specified host and the specified attack type, and specifies a related host and a related log for each step included in the specified attack path, and instructs the specified related host to store the specified related log.

4. The information processing apparatus according to claim 1, wherein
the security alert is intelligence information provided for a cyberattack and includes information indicating an attack type, and
at least one processor specifies the attack type from the security alert, and specifies the attack path related to the specified attack type.

5. The information processing apparatus according to claim 1, wherein
at least one processor further specifies attack steps included in the specified attack path, and specifies the log related to the attack path for each of the specified attack steps.

6. The information processing apparatus according to claim 1, wherein at least one processor further instructs a storage condition of the log for the host.

7. The information processing apparatus according to claim 6, wherein
the security alert includes information indicating a level of urgency, and
at least one processor specifies the level from the security alert, and sets the storage condition of the log according to the specified level.

8. The information processing apparatus according to claim 1, wherein
at least one processor transmits, to the host, data including a type of the specified log and instruction to store the specified log.

9. An information processing method comprising:
specifying an attack path related to a security alert and specifying a log related to the specified attack path in a computer system including hosts; and
instructing the host that handles the specified log to store the specified log.

10. The information processing method according to claim 9, in which
the security alert includes information indicating a host that has been subjected to an attack, and
in the log specifying, the host that has been subjected to the attack is specified from the security alert, and the attack path related to the specified host is specified.

11. The information processing method according to claim 10, in which
the security alert further includes information indicating an attack type,
specifying the attack type from the security alert is further included,
in the log specifying, an attack path related to the specified host and the specified attack type is specified, and a related host and a related log are specified for each step included in the specified attack path, and
in the log instruction, the specified related host is instructed to store the specified related log.

12. The information processing method according to claim 9, in which
the security alert is intelligence information provided for a cyberattack and includes information indicating an attack type, and
in the log specifying, the attack type is specified from the security alert, and the attack path related to the specified attack type is specified.

13. The information processing method according to claim 9, in which
in the related log selection step, attack steps included in the specified attack path are further specified, and the log related to the attack path is specified for each of the specified attack steps.

14. The information processing method according to claim 9, in which
in the log specifying, a storage condition of the log is further instructed for the host.

15. The information processing method according to claim 14, in which
the security alert includes information indicating a level of urgency, and
in the log instruction, the level is specified from the security alert, and the storage condition of the log is set according to the specified level.

16. The information processing method according to claim 9, in which
in the log instruction, data including a type of the specified log and the instruction to store the specified log is transmitted to the host.

17. A non-transitory computer-readable recording medium recording a program including a command for causing a computer to:
specify an attack path related to a security alert and specify a log related to the specified attack path in a computer system including hosts; and
instruct the host that handles the specified log to store the specified log.
